(19) United States
(12) Patent Application Publication
(10) Pub. No.: US 2005/0183770 A1
(43) Pub. Date: Aug. 25, 2005

(54) Linear fluid drive system with detent

(76) Inventor: Robert Metzinger, Calgary (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/060,119

(22) Filed: Feb. 16, 2005

Related U.S. Application Data
(60) Provisional application No. 60/545,483, filed on Feb. 19, 2004.

(51) Int. Cl. G05D 7/00

(52) U.S. Cl. 137/106

(57) ABSTRACT

A switching valve which directs pressurized fluid through alternating pathways in the valve's body is provided, controlled by the cycling of a set of seals between positions, each position providing an alternate fluid pathway. The seals' position during operation is constrained by having the force moving the seals overcome the force of a cam follower on a cam profile to keep the valve from stalling at an equilibrium point.

### CROSS-REFERENCE TO RELATED APPLICATIONS

This application claims the benefit of U.S. Provisional Application No. 60/545,483, filed Feb. 19, 2004, which is incorporated herein by reference.

### FIELD OF THE INVENTION

The present invention relates to a system for ensuring accurate stroke length of a spool in a differential pilot-operated switching valve in a closed well-head power system, independent of variations in differential pressures, and the avoidance of stalling the spool's movement at an equilibrium pressure at a particular point in the spool's travel.

In particular, the present invention relates to the field of providing gas drive to mechanical devices such as pumps and injectors at well-heads, using pressurized gas in a pipeline system to power the mechanical device without flaring or venting “spent” gas.

The present invention has particular application (but is not thereby limited) in the field of gas production in the oil and gas industry, where it is often useful to provide power to energize well production equipment without resorting to externally (or remotely) supplied energy sources such as electrical power, and without using produced gas in internal combustion or other power-generating engines where waste products, heat, and maintenance are issues. The gas used is recirculated to the production line; the system is in that way a closed system.

### BACKGROUND OF THE INVENTION

It is well known to provide for generation of mechanical power (such as powered reciprocal motion by reciprocating piston/cylinder/valve means or rotary motion by turbine, fan, or combined reciprocal piston/crank means) utilizing pressure differentials between produced well-head gas pressure and atmosphere; likewise between produced well-head gas pressures and sales line pressures. Engines in which power is derived from partially expanding pressurized fluid to drive an output shaft are generally preferred over internal combustion. See Patents U.S. Pat. No. 3,801,230, U.S. Pat. No. 4,369,373, U.S. Pat. No. 4,896,505, and U.S. Pat. No. 6,113,357, which each provide means of harnessing either fluid flow or differential pressure to provide mechanically available power for other purposes.

The use of valves and pistons in combination with a fluid operated pressure-powered system is also known. See Patents U.S. Pat. No. 4,439,114 and U.S. Pat. No. 4,616,981, which describe the use of pistons in combination with valves and fluid pressure in a pumping system.

It is also well known to provide for the injection of chemicals into a well bore to assist in the production of desired hydrocarbons or the protection of the well's equipment. See, for example, Patents U.S. Pat. No. 3,901,313 and U.S. Pat. No. 4,776,775. Of course, the injection of material into a well (which is typically at higher than atmospheric pressure) requires the use of mechanical or pressure-providing power sources.

It is known in the art that such power sources may be provided by the use of pressure-differential between well-head produced gas pressures and atmosphere, with the spent gas (that is, once it is relieved to atmospheric pressures after powering the devices required) being released to atmosphere or flared. At current prices for hydrocarbons, in particular natural gases, and with current constraints on pollution of the atmosphere, these techniques are not ideally suited for today's use.

Engines that derive power from partially expanding pressurized fluid to drive equipment are preferred over internal combustion engines because of the absence of the involvement of volatile combustible fluids and the resulting exhaust gas which gives rise to pollution and safety concerns.

Several innovations have arisen due to those problems, such as the devices offered for sale and installation by ABI Oil Tools e-tronics Corp. under the trade name “Zero Emission Blair Air System”, which powers a traditional venting glycol pump replacement with a closed-loop system in a containment device, depending upon the differential between well-head pressures and sales line pressures, which may be very high pressures, and may be very different pressures, and may be pressurized gases including corrosive or dangerous substances the release of which at high pressures could be problematic.

U.S. Pat. No. 6,694,858 describes a system for directing pressurized gas from a pipeline through a switching valve, to drive a power unit with a reciprocating piston. The power unit piston, in turn, operates a pump or other mechanical device to be powered. The switching valve may include a spool movable in linear fashion within a chamber. Two sets of cavities are formed continuous with the chamber, and the spool also includes sealing means to permit or prevent communication between chamber cavities depending on the position of the spool within the chamber. For example, when the switching valve's spool is moved to one extreme, high pressure pipeline gas will flow through the conduit formed between one set of communicating chamber cavities, and through to the power unit, driving the power unit's piston completely in one direction, while another pathway will be isolated by the sealing means for exhausting spent low pressure gas from the opposite side of the power unit's piston. When the piston has been maximally driven in one direction, pressure builds within the conduit such that a flow control valve is opened, allowing the high pressure gas to provide back pressure to the spool, driving it in the opposite direction. The spool will be driven into a position such that a conduit is formed between an alternate set of chamber cavities, allowing high pressure pipeline gas to flow through to the opposite side of the power unit, thereby driving the piston of the power unit in the opposite direction, with the gas on the previously driven side of the piston being exhausted through an alternate conduit now isolated by the spool sealing means.

One potential shortcoming of the above system is the potential for stalling of the spool. During operation, due to the rapid reciprocation of the spool, and given that the gas volumes at either end of the spool act as closed systems, there will always be an abrupt drop in pressure of the higher pressure gas acting on one end of the spool and an abrupt increase in pressure of the lower pressure gas acting on the other end of the spool during spool travel. As the spool reciprocation moderates due to changing input and/or output conditions, the resultant pressure on the high pressure end of the piston and the resultant pressure on the low pressure side can come to an equilibrium of pressure, at which point the piston will stall. Therefore, the pressure at the two end chambers adjacent to the spool will tend to equalize with changing input and/or output conditions, resulting in a decreasing spool stroke length, leading to eventual stall of the spool. Due to the location of the seals along the spool, the decreased stroke length may eventually result in the spool reciprocating minimally between two positions in which neither conduit will be opened, resulting in temporary power failure due to the inability to permit gas flow past the valve. This can mean that when gas pressure differential elevates, the spool will not be re-motivated without manual intervention, and the stall will thus require well-head servicing to resume operation.

It is therefore desirable to provide a source to energize equipment at the well-head in the form of reciprocating motion without venting or flaring exhaust gas, and with reduced risk of equipment stalling and power failure, even if temporary. The goal of achieving self-maintaining long-term operation is desired.

### SUMMARY OF THE INVENTION

It is an object of this invention to overcome the limitations in the prior art. The existing prior art inadequately addresses the need for a recirculating linear gas drive system that utilizes pressurized gas, a simple closed valve and a piston drive system to drive a mechanical device, such as a pump, eliminates the need to routinely flare or release “spent” gas to atmosphere, and is not susceptible to stalling over long periods of continuous use and changing operating conditions.

The present invention has particular application (but is not thereby limited) in the field of gas production in the oil and gas industry, where it is often useful to provide power to energize well production equipment without resorting to externally (remotely) supplied energy sources such as electrical power, and without using produced gas in internal combustion or other power-generation engines where waste products, heat, and maintenance are issues. The use of pressurized gas with the present invention's features also assists in preventing the system from stalling and will cure difficulties overcoming the friction of the driver.

These and other objects and advantages of the present invention are apparent in the following descriptions of the preferred embodiments of the present invention, which are not intended to limit in any way the scope or the claims of the present invention.

### BRIEF DESCRIPTION OF THE DRAWINGS

Preferred embodiments of the present invention will now be described, by way of example only, with reference to the attached Figures, wherein:

FIG. 1 is a schematic representation of the switching valve system of the present invention, shown driving a power unit;

FIG. 2a, 2b, and 2c are schematic representations of the switching valve with cam profiled detent spool and cam followers, showing the spool in various positions during reciprocation; and

FIG. 3 is a schematic representation of the cam profile and cam follower, showing the relative relationships of each.

### DETAILED DESCRIPTION OF THE INVENTION

The preferred embodiment of the present invention includes high pressurized gas supplied from a pipeline well-head, pipe, a switching valve complete with manifold system for directing the gas flow and a power unit with piston. The switching valve includes a detent system in which the spool has a cam profile portion 10 for engaging a cam follower 11 to force a full extension of the spool in either direction, or in other words, to keep the spool out of a stalled position of pressure equilibrium. In conditions of low pressure differential (between the two sides of the spool), in which the spool would not be fully reciprocated, the detent system 10 and 11 will prevent spool movement until such time as there is sufficient pressure differential to overcome the cam profile and fully reciprocate the spool, rather than permitting the spool's seals to partially open both sides, or be caught within a segment of the spool's operating range when neither high pressure conduit is open to power the piston's reciprocation.

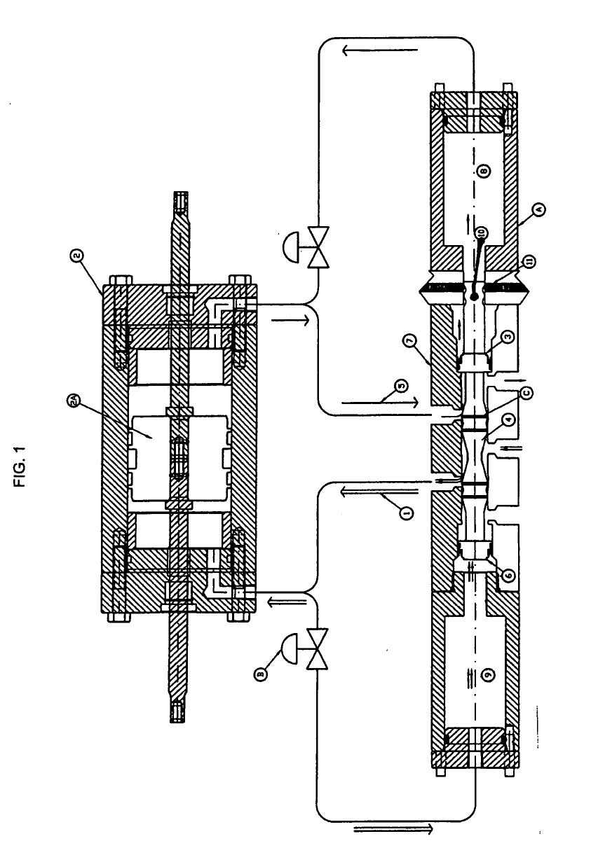

FIG. 1, 2a, 2b and 2c illustrate a preferred embodiment of the present invention comprised of:

A-switching valve

B-flow control valve

C-seals

1-higher pressure gas

2-power unit

2a-power unit piston

3-first piston end of spool

4-spool

5-lower pressure gas

6-second piston end of spool

7-valve housing

8-first end chamber

9-second end chamber

10-cam-profiled detent portion

11-cam follower

In FIG. 1, the higher pressure or produced gas 1 is obtained from a high-pressure gas source, typically a conventional well-head with fittings and valves, and the like.

The higher pressure or produced gas 1 flows through the switching valve A and is directed by the spool 4, to one of the sides of the power unit piston 2a in the reciprocating power unit 2.

The higher pressure or produced gas 1 pushes the power unit piston 2a contained within the power unit 2, transmitting the piston's powered stroke to a mechanical device requiring power.

At the same time, spent lower pressure gas 5 on the opposite side of the power unit piston 2a and end chamber 8 is exhausted through the switching valve A to pipeline in a closed system.

During approximately the same time, high-pressure gas 1 flows through the flow control valve B to provide drive-pressure to the spool 4, to force the cam-profiled detent portion 10 of the spool 4 to overcome the force of the cam follower 11, pushing the spool 4 toward one end position.

The spool 4 moves linearly within the switching valve A, closing one flowpath and opening another, and thus reversing the flow of both spent lower pressure gas 5 and high pressure gas 1.

Once the flow direction is reversed, the process may be continuously repeated.

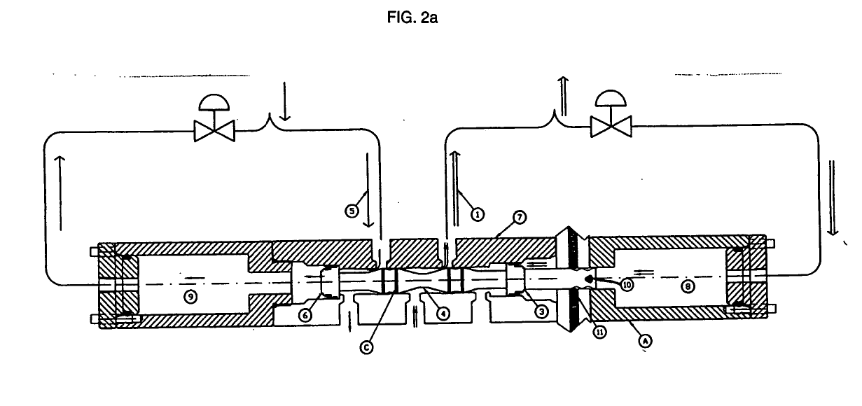

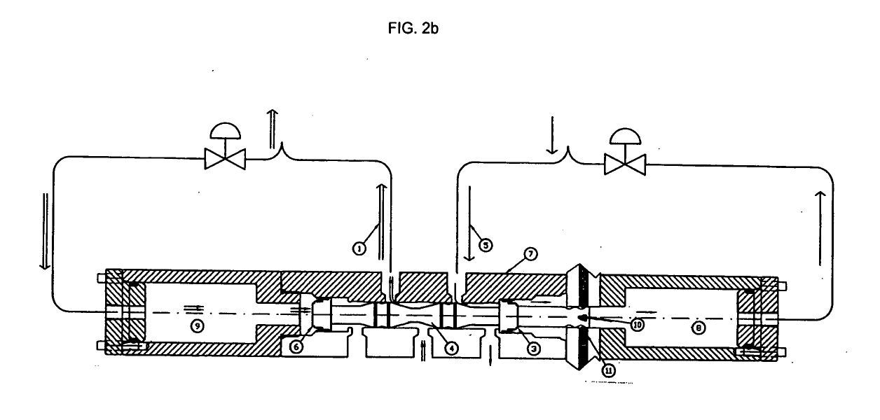

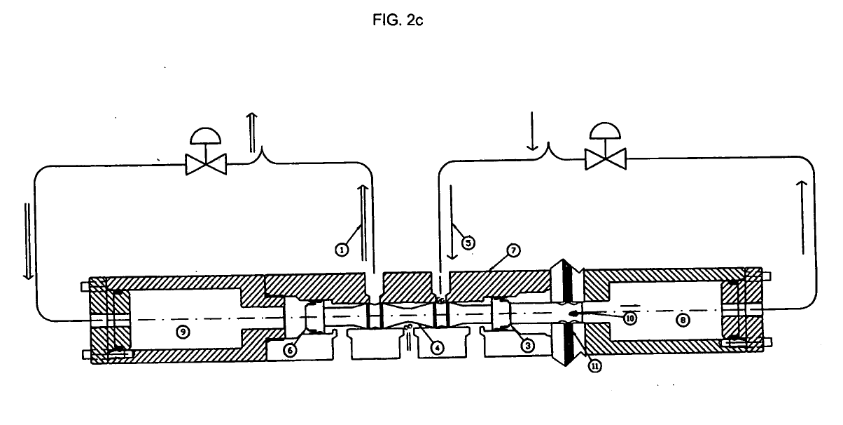

In FIG. 2a, the cam follower 11 is engaged with the leftmost cam profile/camface of the detent portion 10, causing the spool 4 to be in its most extreme right position. As the high-pressure gas 1 applies back pressure to the first piston end 3 of the spool 4, the pressure of the detent portion 10 against the cam follower 11 will increase until the back pressure of the higher pressure gas 1 overcomes the pressure exerted by the cam follower 11, causing the spool 4 to be driven leftward. Thus, the rightmost cam profile of the detent portion 10 will now be engaged with the cam follower 11, as shown in FIG. 2b.

The spool seals C are arranged such that when the cam follower 11 engages either cam profile of the detent potion 10, a conduit or flowpath will be opened, enabling high pressure gas 1 to pass, and the switching valve A and associated equipment will not stall.

The speed, power and time delays of the operation are controlled using adjustable flow control valve B and the stroke of the power unit piston 2a may be optimized by using variable length piston sleeves.

Instead of a spool with pistons, the sealing device could be driven by diaphragms or similar pressure-differential driven systems with similar switching valve body and detent system.

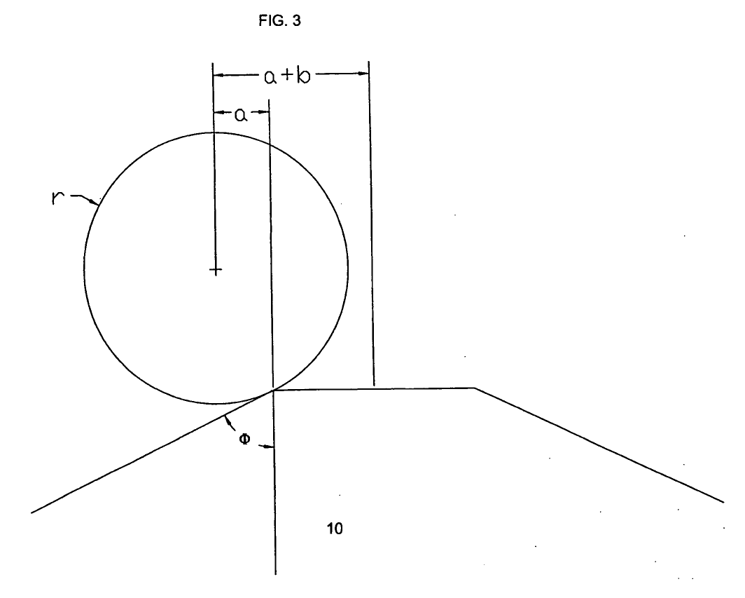

Testing was carried out to determine the preferred relationship between the cam profile 10 and the cam follower 11 release point. It was found that for typical field conditions of input pressure ranging from 12 psi to 5000 psi, with the range of pressure differential (between high pressure supply and pipeline pressure exhaust) being from 12 psi to 75 psi conditions used, the release point is 2/3×cos φ×r=a, where a is the distance from the cam edge as shown in FIG. 3. When used in conjunction with the known seal versus port overlap the required center flat b was determined. The same relationships were used to minimize the flat by varying follower size.

The detent system is preferably made of tungsten carbide or ceramic, but could also be made of any other conventional or known material suitably inert, having suitable compressive strength, and having appropriate hardness at a wide range of temperatures. Further, the material should have a similar expansion coefficient to the surrounding pieces when press-fit together.

In the foregoing description, the present invention has been described in its preferred embodiments. However, it will be evident that various modifications and changes may be made without departing from the broader scope and spirit of the present invention. Accordingly, the present specifications and embodiments are to be regarded as illustrative rather than restrictive.

The descriptions here are meant to be exemplary and not limiting. It is to be understood that a reader skilled in the art will derive from this descriptive material the concepts of this Invention, and that there are a variety of other possible implementations; substitution of different specific components for those mentioned here will not be sufficient to differ from the present invention described where the substituted components are functionally equivalent.

The above-described embodiments of the present invention are intended to be examples of the present invention. Alterations, modifications and variations may be effected the particular embodiments by those of skill in the art, without departing from the scope of the present invention which is defined solely by the claims appended hereto.

1. A switching valve comprising:
multiple flowpaths for permitting the passage of fluid;
a sealing system for selectively sealing the flowpaths to prevent passage of fluid through a sealed flowpath while permitting passage of fluid through another flowpath, the sealing system moveable between selected positions of sealing and unsealing with respect to the flowpaths; and
a detent system for preventing the sealing system from remaining in a position in which all of the flowpaths are sealed

2. The switching valve system of claim 1 further comprising a pressurized fluid provided to the switching valve system for flowing through an unsealed flowpath to an external destination, and wherein each flowpath further comprises a bypass path continuous with each flowpath and continuous with the sealing system such that the pressurized fluid flowing through the unsealed flowpath will also flow through the bypass path to become a drive system for powering movement of the sealing system.

3. The switching valve system of claim 1 wherein the sealing system is a reciprocating spool within a valve housing, the spool having at least one seal ring for releasably sealing each of the at least two flowpaths.

4. The system of claim 3 wherein the spool has first and second ends, and wherein a drive system provides force to alternating ends of the spool to reciprocate the spool within the valve housing, thereby repeatedly sealing and unsealing the at least two sealable flowpaths.

5. The system of claim 3 wherein the detent system includes a linear cam and cam follower system, the cam having a fixed number of cam profiles corresponding to the fixed number of flowpath sealing positions.

6. The system of claim 5 wherein the linear cam is on the spool, and wherein the cam follower is part of the valve housing.

7. The system of claim 5 where the linear cam is part of the valve housing and the cam follower is attached to the spool.

8. A double-acting reciprocating switching valve system comprising:
a reciprocating power system having first and second chambers, one at each side of the reciprocation;
a switching valve associated with a high pressure fluid source, the switching valve having a valve housing having first and second ends, first and second fluid flowpaths extending through the valve, each fluid flowpath sealable by a sealing spool reciprocating within the housing, and a detent system having cam profiles and cam followers for controlling movement of the spool;
a first high pressure fluid pathway between the first flowpath of the switching valve and the first chamber;
a second high pressure fluid pathway between the second flowpath of the switching valve and the second chamber;
bypass pathways associated with each high pressure fluid pathway, each bypass pathway forming a conduit from a high pressure fluid pathway to the respective first or second end of the valve housing such that when a high pressure fluid is supplied to the valve when the first flowpath is open, high pressure fluid will flow through the valve to the first of the power system's chambers to drive the power system's reciprocation toward the second chamber, and causing high pressure gas to also flow through the corresponding bypass pathway to apply force to the spool at the first end of the housing such that the force applied by the cam follower to one of the cam profiles is overcome, and such that the spool is driven towards the second end of the housing to close the first high pressure flowpath and open the second high pressure flowpath, thereby allowing high pressure gas to flow to the second of the power system's chambers to drive the power system's reciprocation back toward the first chamber (and so forth).
